(19) United States
(12) Patent Application Publication
(10) Pub. No.: US 2016/0346906 A1
(43) Pub. Date: Dec. 1, 2016

(54) Rotational Tool Bit

(71) Applicant: Daniel L. Pinckard, Vancouver, WA (US)

(72) Inventor: Daniel L. Pinckard, Vancouver, WA (US)

(21) Appl. No.: 14/624,843

(22) Filed: Feb. 18, 2015

(51) Int. Cl. B25B 15/00; B25B 21/02

(52) U.S. Cl. CPC B25B 15/005; B25B 21/023

(57) ABSTRACT

An improved rotational tool bit used for operational engagement with a Phillips head style fastener that has two points formed at the end of each of its four symmetrical wings and two concave side wall faces on the wing. The points can bite into the fastener and reduce the cam out effect. The design of each of the four wings places the thickest section of the wing behind the two points, aligned facing the reactionary force generated by the torque applied in rotating the fastener so as to prevent deformation of the points under load.

The present invention relates to an improved driver bit for enabling rotational engagement of a mechanical fastener. More particularly, for use with mechanical fasteners that use Phillips style heads. This bit is adapted to provide both safety, enhanced workability and convenience for the user.

### BACKGROUND OF THE INVENTION

The Phillips style heads of mechanical fasteners were originally developed to simplify production assembly. At the time of their development, slotted head fasteners were the norm. Unfortunately, for automated screwdrivers on assembly lines, the torque loads they could provide before cam-out were low. Additionally, the slip out encountered by slotted bits lead to dangerous situations. Besides providing an instant feel of correct fitting engagement, the four symmetrical wing design of Phillips style driver bits provided the following main mechanical features: the automatic centering of the bit into the fastener's top recess; the ability for the bit to hold the fastener thereon (either as magnetized or vertically positioned); the ability to force cam-out of the bit from the fastener once the threshold amount of rotational torque is reached; and to provide a bit-to-fastener engagement that allows for a significant increase in the amount of rotational torque that could be successfully applied to a conventional slotted head fastener. Today much of the production fasteners have been changed to one of the multi point recessed head systems or hexagonal head systems to allow even higher torque applications.

Although the original Phillips style driver bit that matingly conformed to the Phillips style head geometry offered significant improvements over the existing prior art fastener systems, it also had several drawbacks. First, the amount of torque that could be applied was limited to the amount of contact force the user could maintain between the bit and the fastener, in opposition to the cam-out forces. Second, the fastener head recess or the bit wings would round and strip as the bit “cammed-out” of the fastener and less of the bit wing and fastener recess were in contact with each other. This is a common occurrence with fasteners that self tighten in operation and require a reverse direction extraction torque beyond their initial installation torque.

Henceforth, an improved driver bit that would reduce cam-out and allow the application of higher torque loads to a Phillips style head fastener, would fulfill a long felt need in the mechanical fastener industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a Phillips style driver bit that is able to allow the application of higher torque loads over conventional driver bits, without stripping themselves or the fastener head. It is a second purpose of the present invention to provide a driver bit for a Phillips style fastener that has a mechanism to reduce the amount of cam-out force that acts to drive the bit out of the fastener head. It has many of the advantages mentioned heretofore and many novel features that result in a new rotational tool bit which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front side view of the improved rotational tool bit showing the general arrangement of the three sections;

FIG. 2 is an axial cross sectional view of the conventional Phillips style screw and bit configuration;

FIG. 3 is an axial cross sectional view of a common variation of the Phillips style screw and bit configuration;

FIG. 4 is a front side view of the improved rotational tool bit showing the location of cross section A-A;

FIG. 5 is a perspective view of the improved rotational bit from the proximate end;

FIG. 6 is a cross sectional view of the improved rotational bit taken through section A-A with phantom illustrations of the gully side walls;

FIGS. 7 and 8 are cross sectional views of the geometry of the four wings taken through section A-A;

FIG. 9 is a back view of the improved rotational tool bit;

FIGS. 10, 11 and 12 are a series of cross sectional views of a screw head, a screw head with tool bit inserted and a screw head with screw inserted with clockwise torque applied;

FIG. 13 is a cross sectional view of the improved rotational tool bit in a manual application.

FIG. 14 is a cross sectional partial view of a HY torque bit in a screw recess;

FIG. 15 is a cross sectional partial view of a HY torque bit;

FIG. 16 is a cross sectional partial view of a HY torque bit with a deformed corner tip;

FIG. 17 is a partial cross sectional top view of a view of the improved rotational tool bit in a screw recess under torque;

FIG. 18 is a cross sectional view of one wing the improved rotational tool bit showing the strengthened design; and

FIG. 19 is a cross sectional drawing illustrating the included angle of each of the points on a wing.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As used herein, the term “contiguous” means immediately next to each other and joined.

As used herein the term “regular hexagon” means a polygon with six equal sides and angles.

As used herein the term “consecration cross” refers to a geometric cross shape having four identical wings that are evenly spaced and extend from a midpoint of the cross, where the perimeters of the outer ends of the four wings lie on equal radial sections of a circle sharing the same midpoint as the cross. The wings are separated by four evenly spaced identical gullies there between where each gully has at least two concave walls. It is often referred to as a rounded cross.

As used herein “cylindrical solid body” means a linear mass having a cylindrical axial cross section when taken perpendicular (normal) to its linear axis at all points along its linear axis. The outer diameter of the cylindrical body may vary along its length as the outer surface of the body may taper or contour.

As used herein the term “cam out” or “throw out” refers to the outward separation of the bit from the screw recess upon the application of torque.

As used herein the term “truncated cone” refers to a cone that does not end in an apex or point but rather has a pair of parallel planar circular faces residing normal to the linear axis of the cone, one at either end.

It is to be noted that the present rotational Phillips style bit discussed and dimensioned herein represents a No. 2 sized bit. The theory of operation and design disclosed herein applies equally to all other size bits although the dimensions will vary.

On Jul. 7, 1936, four patents were awarded to Henry F. Phillips entitled “Screws” (U.S. Pat. No. 2,046,343), “Means for Uniting A Screw with a Driver” (U.S. Pat. No. 2,046,837), and two separate patents on “Screw Driver[s]” (U.S. Pat. No. 2,046,840 and U.S. Pat. No. 2,046,838). These shared the common Phillips geometry of a crucifix (Frearson) recess. At the time, these provided a huge innovative leap in the efficiency and safety of how production screws could be fastened. Phillip's patents boasted of a self centering design for a driver bit 2 that when mated to a generally matingly conformed screw, provided a safe, firm wedging engagement that would not slip off in power driven applications.

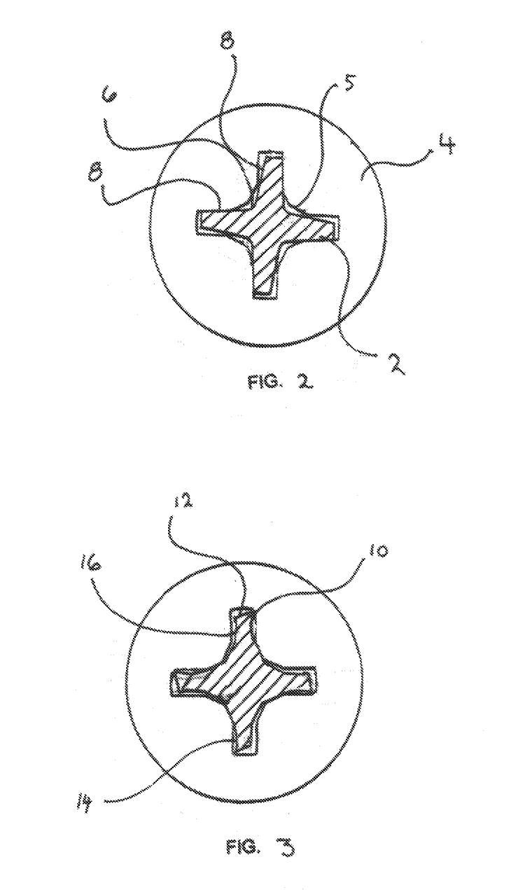

Today, however, the industry standard follows the modified cruciform recess 4 formed in the screw head as shown in the two patents of Joseph J. Tomalis. (U.S. Pat. No. 2,474,994 and U.S. Pat. No. 2,507,2.) (FIG. 2) This incorporates a multi faceted side wall 5 of angular contiguous wall portions.

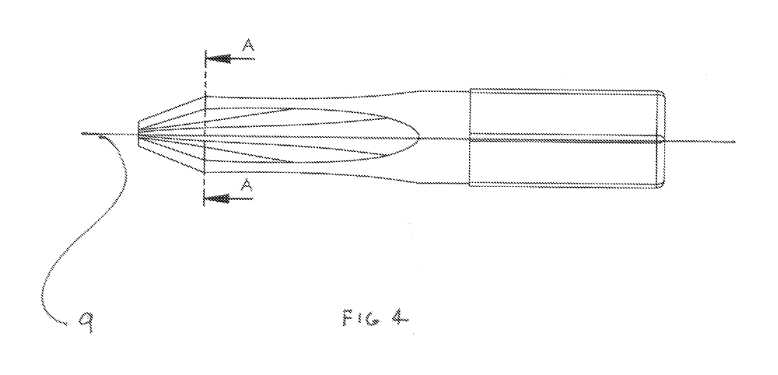

One of the largest drawbacks of the Phillips bit and screw design has been the cam out or throw out that occurs upon the application of torque. This is a common problem when installing self-tapping or self-drilling screws that require a heavy driving torque. Another major problem is that the bit and screw must remain in a tight axial alignment during use or the bit will climb out of the screw. These problems have been addressed several times, and numerous improvements to compensate for this shortcoming have been developed, the most successful and notable is seen in the works of Louis. A. Cummaro (circa 1955) and documented in U.S. Pat. No. 2,859,782 entitled “HY Torque Drive Tool.” This HY torque design bit 10 (FIG. 3) eliminated the radiused (rounded) transition interface 6 between the sides walls of adjacent wings 8 and incorporated into the bit the substantially conforming Tomalis profile of a multi faceted side wall 5. Thus when inserted into the screw recess and turned, the side wall on vane in the direction of rotation contacts the wall of the screw head (since these walls have the same relative angular disposition) firming a wedging action that allows the screw to be turned. (FIG. 3) The major improvements of Cummaro however, removed part of the outermost (highest) planar side face 14 of the multi faceted side wall on one side of the vane so as to develop a knife edge or point at the corner tip 16 that would be the first point of contact between the bit and the screw. The opposing side of the vane 16 remains convex. Cummaro also added a radius to this outermost flat face 12 on the top of the wing to eliminate interference at the back corner of this face and increase the included angle of the knife edge to approximately 87 degrees. This design offered a substantial reduction of the cam out effect for a given amount of torque over the prior art bits. The 87 degree point allowed the bit to “bite” into the side wall of the screw head reducing the potential for stripping when under higher torque loads.

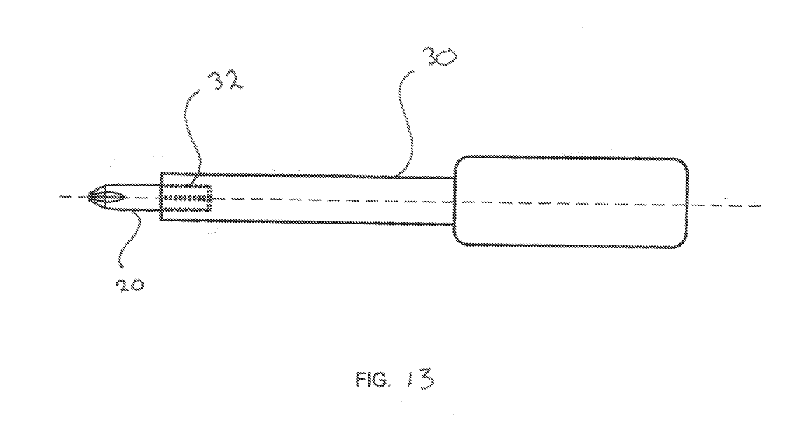

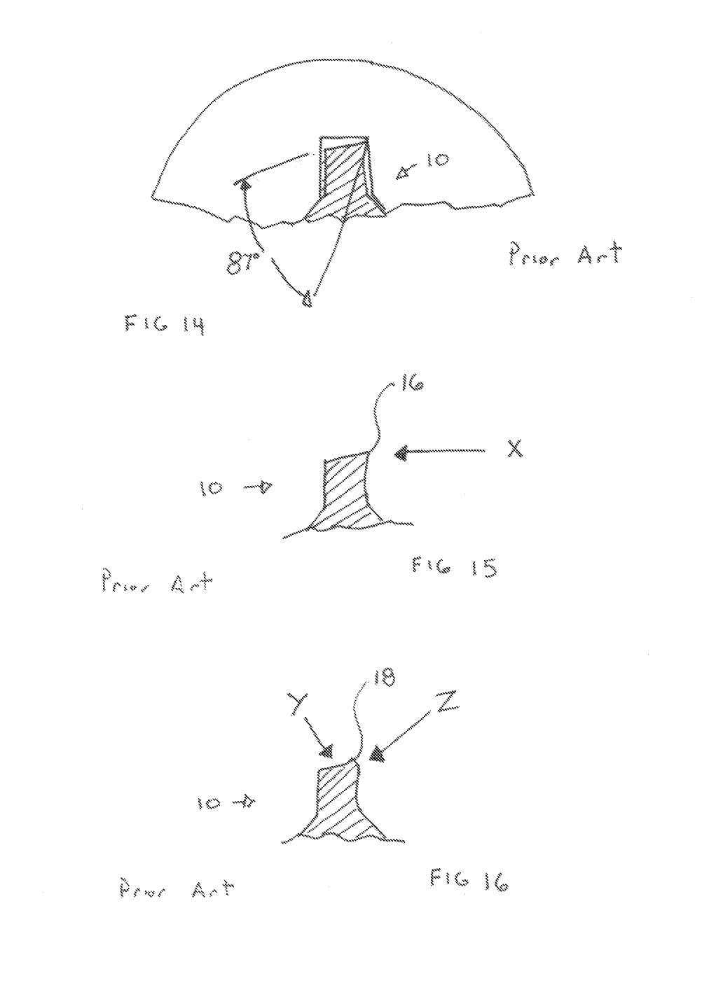

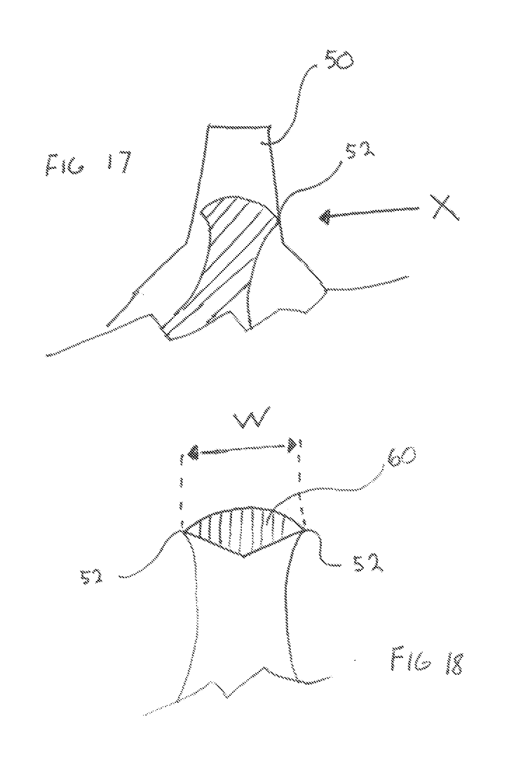

The drawbacks of the HY torque bit 10 were that it does reduce the cam out force for screw removal where the direction of the torque is reversed, but more importantly, before cam out occurs, upon the application of enough torque, the bit strips at the corner tips 16. Looking at FIGS. 14 and 15, the 87 degree corner tip 16 can be seen in and out of a screw recess. The bit failure can be see in FIG. 16 wherein after the application of torque, the reactionary force designated as X acts to deform the corner tip 16 to the shape of the area designated as Z because of the lack of material support behind the corner tip 16 in the region designated as Y. The 87 degree corner tip 16 inelastically deforms under high torque loads because the corner is unsupported. This then allows the multi faceted side wall on one side of the vane to contact the screw recess and reduce the amount of torque required for cam out.

The present invention provides an improved tool bit 20 that strengthens the area behind the corner tip minimizing corner tip failures, moves the position of the corner tip towards the linear axis of the bit, increases the spacing between the side wall of the vane and the screw recess and simplifies its fabrication.

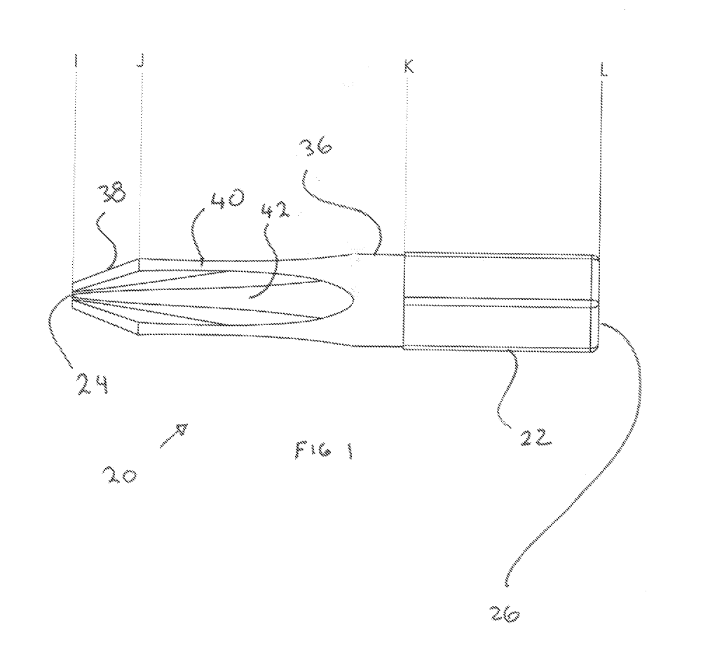

Looking at FIG. 1 the improved tool bit can be seen in side view. The bit 20 has a solid body made of three consecutively contiguous sections. It has a proximate end 24 and a distil end 26. The first section 22 lies between point K and L. When viewing this section from the distil end 26, it can be seen that in axial cross section it has a regular hexagonal configuration with each of the six corners 28 rounded slightly to allow for ease of access into the industry standard matingly corresponding recess 32 such as would be found in the end of screwdriver 30 of FIG. 13. The industry standard nominal diameter shown by dimensional arrow E is 0.250 inches. Each of the six faces from the center of their radiused corners as shown by dimensional arrow is approximately 0.125 inches wide. The outer peripheral edge 34 is also rounded slightly to allow ease of insertion into recess 32.

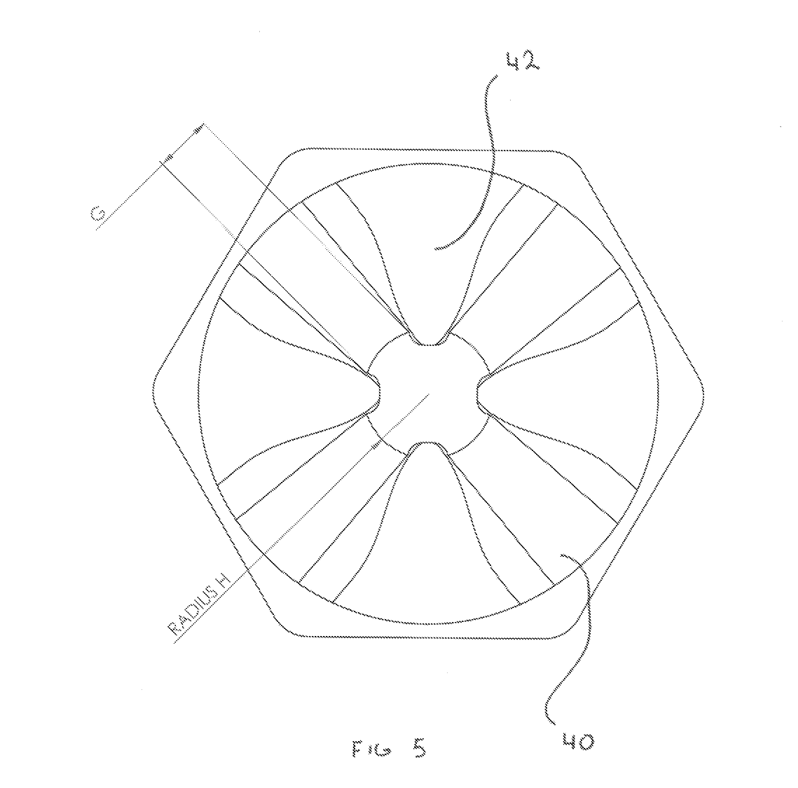

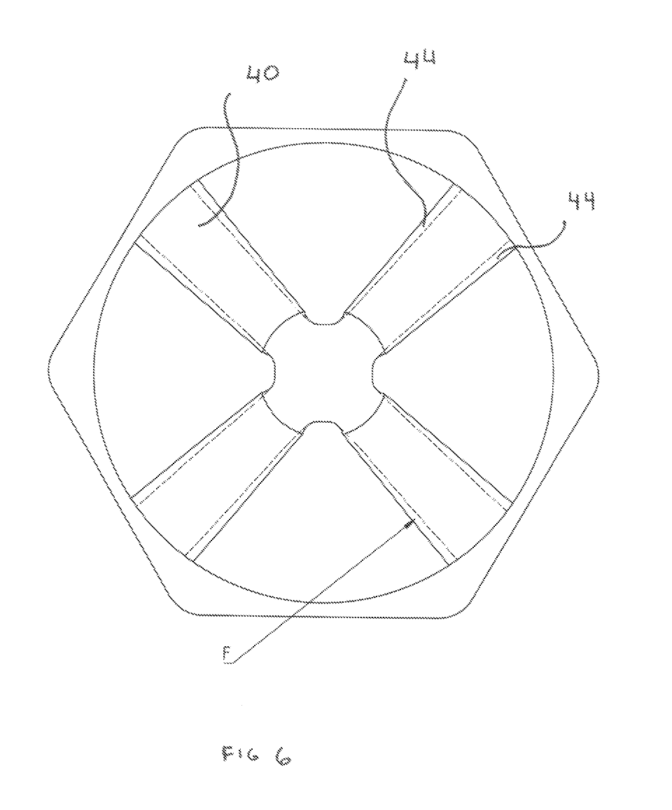

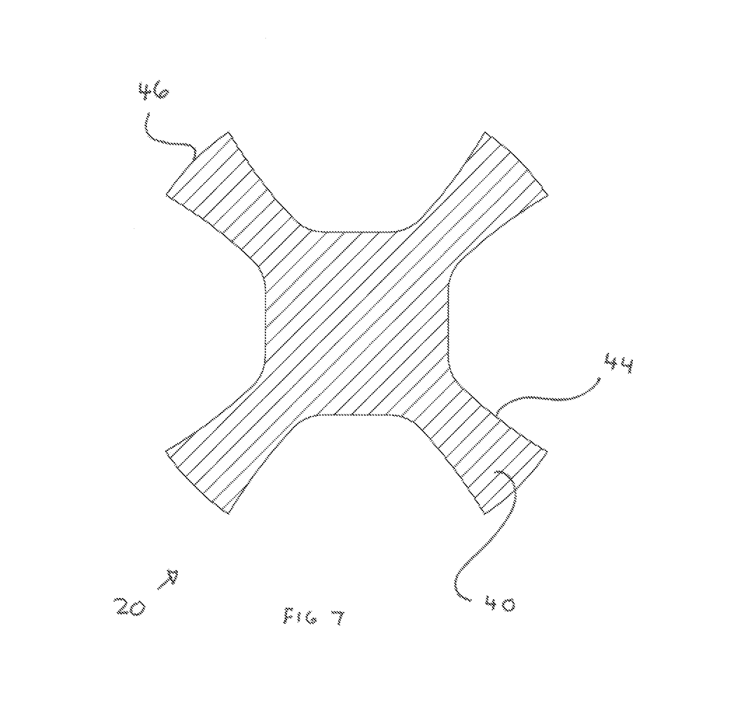

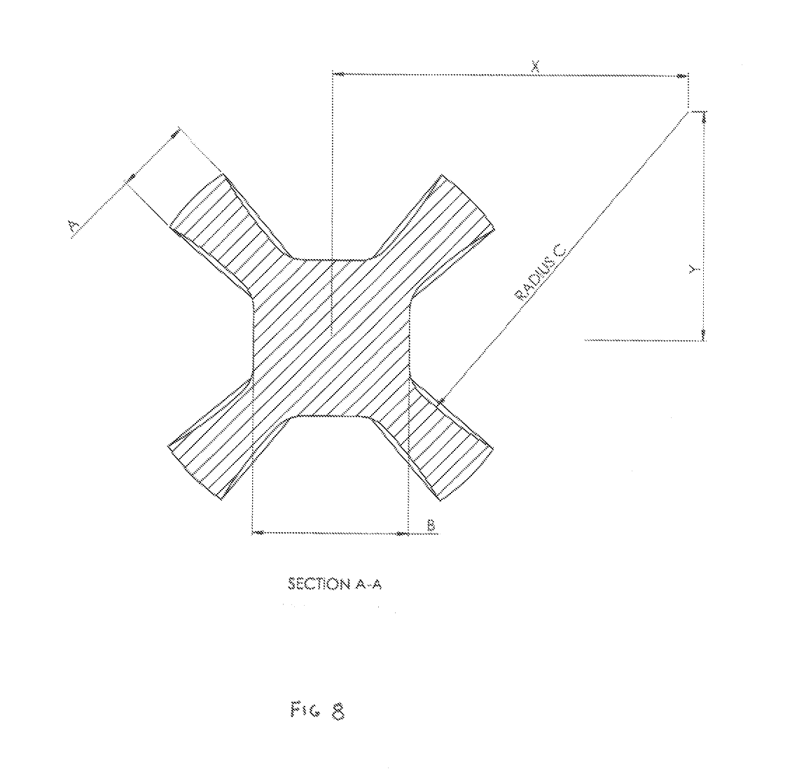

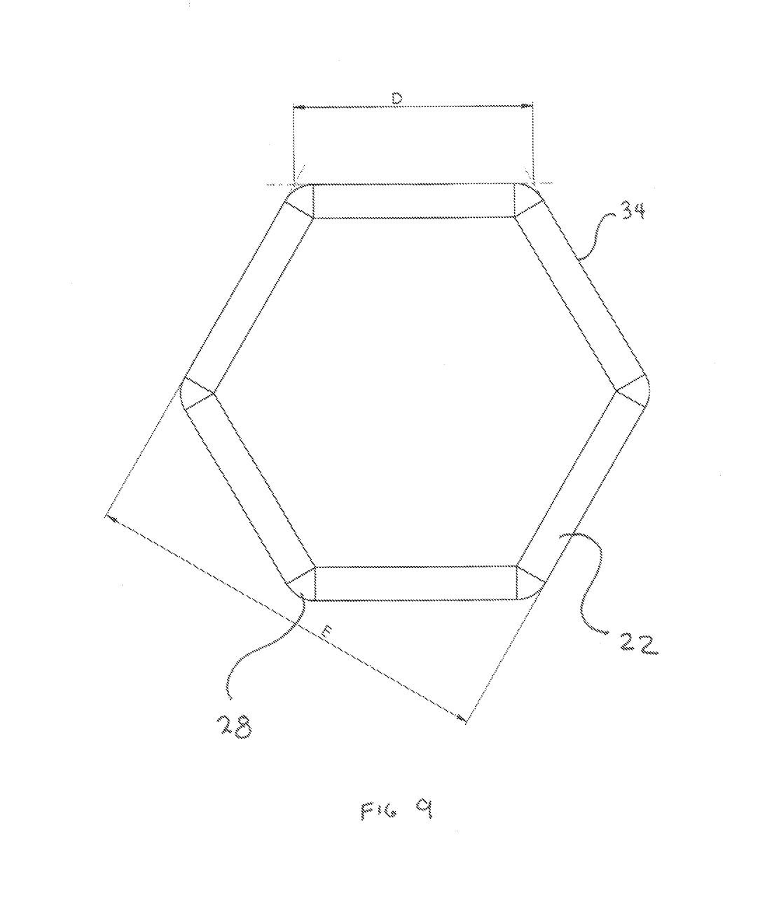

The second section lies between point J and K. It is generally rounded in axial cross section although it may not necessarily be of uniform diameter along its length. Parallel to the linear axis 9 of the bit 20 are four symmetrical, evenly radially spaced wings 40 defined by the removal of material to form four symmetrical, evenly radially spaced gullies 42, best seen looking at the bit 20 from the proximate end of FIG. 5. The wings 40 each have an outer face 46 having a radius with its midpoint lying along the linear axis of the bit 20. Each of the wings 40 have two concave sides 44 indicated by phantom lines 44 having a depth indicated by the arrow F of FIG. 6. In the preferred embodiment, these concave sides 44 have a radius of 0.23 inches from a center point lying 0.21 inches from a plane through the linear axis of the bit 20 passing through the midpoint of the gully 42 on one side of the wing 40 (designated by dimension arrow X) and 0.14 inches from a plane through the linear axis of the bit 20 passing through the midpoint of the gully on the other side of the wing (designated by dimension arrow Y) (FIG. 8). Looking at the axial cross section of FIG. 4 taken through section A-A it can be seen that the gullies formed there between the wings give the bit 20 a consecration or rounded cross (FIG. 7). In the preferred embodiment the bit is 1.350 inches long, with a third section length of 0.170 inches, a second section length of 0.680 inches and a first section length of 0.500 inches. The maximum width of the wing 40 taken at cross section A-A at the outer face 46 is 0.046 inches. The radius of the proximate end designated as Radius H is 0.033 inches. The maximum width of the wing 40 at the proximate end taken at the outer face 46 and designated by dimension arrow G is 0.046 inches (FIG. 5).

The third section 38 lays between point I and J. It is an extension of the second section but the outer face 46 of the wings tapers evenly from their interface with the second section to the proximate end narrowing from 0.25 inches in diameter to 0.066 inches in diameter. Its configuration is that of a truncated cone such that the proximate end is a planar face.

As can be seen, all the gullies 42 and the wings 40 are symmetrical about any plane extending from the linear axis of the bit 20 and passing through the center of the wing 40 or gully 42. In this manner the bit acts identically whether backing out or tightening screws.

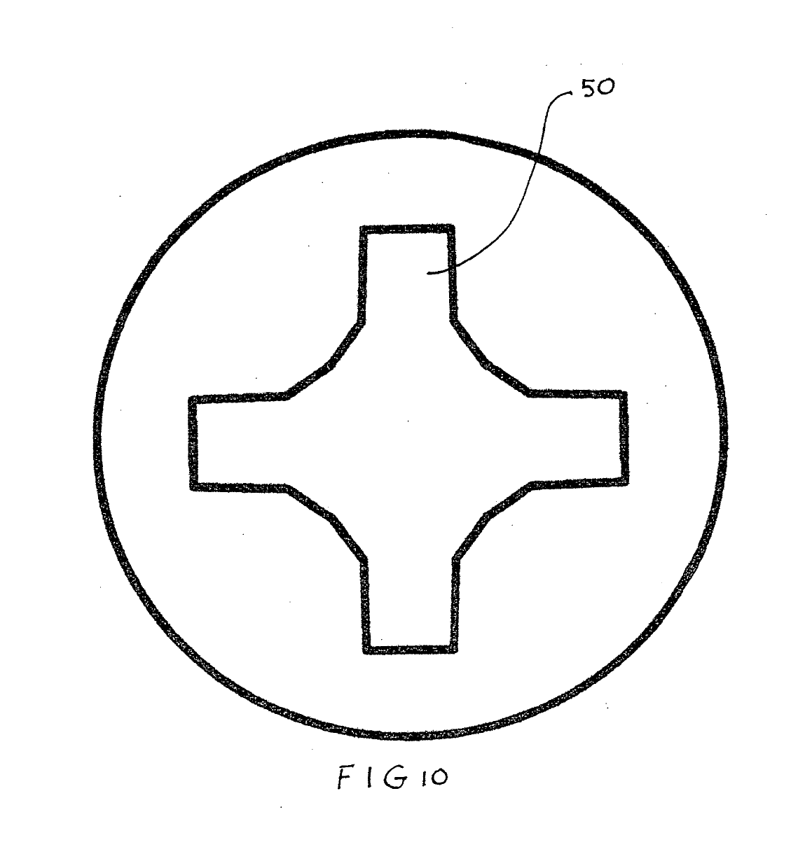

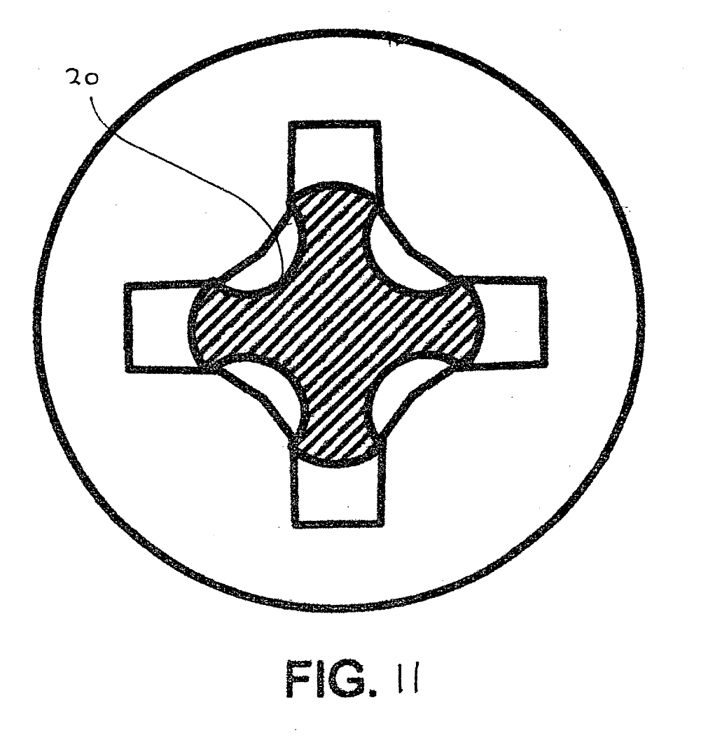

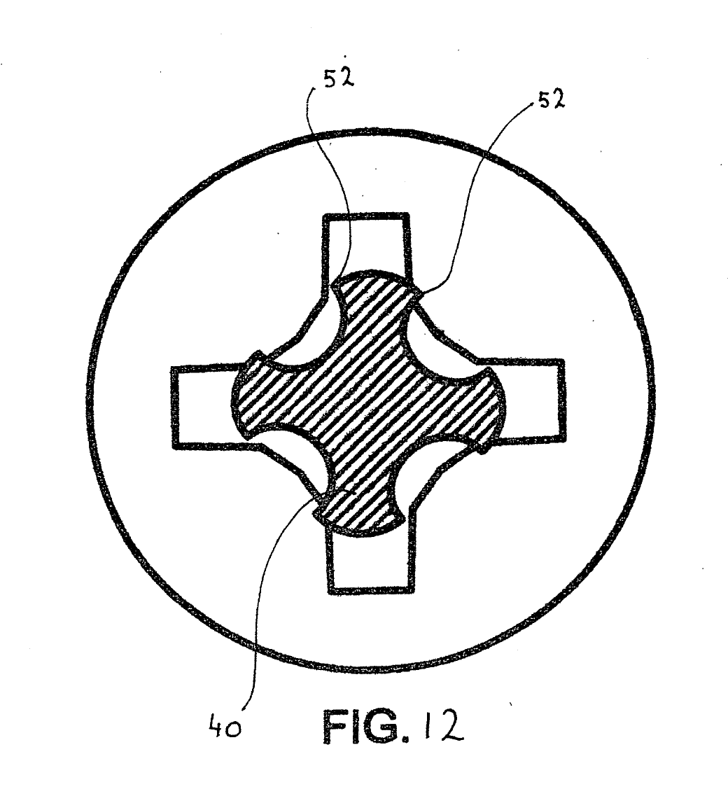

Looking at FIGS. 10-12 the screw recess 50 and the bit 20 can be seen is relation to its insertion and under applied torque. When the bit 20 is inserted into the recess of a standard Phillips-head fastener and torque applied, initial contact is created between the screw recess 50 and one of the points 52 of each wing 40.

As can be seen there are two points 52 on each wing 40 and the thickness of the wing is greatest at a line drawn between the points. This line is also perpendicular to the reactionary force X generated under torque. This provides additional material behind each of the points 52 that keep them from deforming under the load of the reactionary force. It can be seen that much of the wing exists beyond (further from the linear axis) a straight line drawn between the points 52.

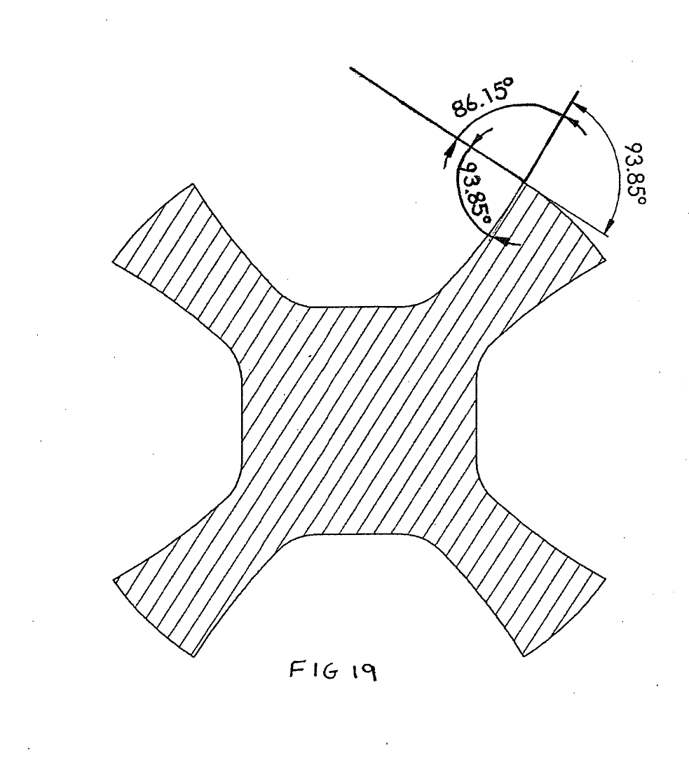

The shades section 60 of FIG. 18 represents the additional mass of steel that has been added behind the points 52 to prevent their upward deflection. Dimensional arrow W symbolizes the thickness of the wing 40 behind (and between) the points 52. With the selected radius C of the wing side wall there is no possibility of any contact between the screw and the remainder of the wing sidewall ensuring all the torque is applied to the “biting” points 52. The improved bit 20 overcomes all the weaknesses of the prior art and provides a bit that has substantially reduced cam out, resists corner point deformation (bit stripping) and can drive screws equally well in either direction. Looking at FIG. 19, it can be see that the included angle of the point is less (sharper) than that of the prior art 87 degrees and has the thickest section of the wing (stronger) behind the point that is parallel to the reactive force trying to bend and deform the corner (less likely to deform).

Because of the high point loads put on the top corners of the wings when torque is applied, the bit will be made of high carbon steels or tool steels enhanced with hardening materials such as silicon accompanied with heat treatment processes designed to harden the steel. This will allow the bit to “bite” into the softer metal of the screw thereby countering the cam out action under applied torque. In the preferred embodiment the bit will have a hardness registering greater than 55 on the Rockwell C hardness scale, preferably in the HRC 55-66 ranges. For example, the steel referred to as AISI No. A3150, a high carbon steel having about 0.48-0.53% carbon, 0.70-0.90% manganese, 1.1-1.40% nickel, and 0.70-0.90% chromium contained therein, may be used.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. An improved rotational tool bit for operational engagement with a Phillips head style mechanical fastener comprising:
a solid linear body having a linear axis and said linear body having a first, a second and a third sequentially contiguous sections, said linear body having a proximate end on said third section and a distil end on said first section;
wherein said first section is a regular hexagonal body in axial cross section, and said second section is a generally cylindrical body, and said third section is a generally truncated conical body, wherein said second and said third sections each have at least two symmetrical, evenly radially spaced wings formed thereon, each wing with two concave side walls, said wings separated by at least two symmetrical, evenly radially spaced gullies.

2. The rotational tool bit of claim 1 wherein the number of wings is four and the number of gullies formed there between said wings is four, such that when viewed in axial cross section said tool bit forms a consecration cross.

3. The rotational tool bit of claim 2 wherein said third section evenly tapers toward said linear axis along its length, narrowing in axial cross section toward said proximate end.

4. The rotational bit of claim 3 wherein each of said wings has a pair of concave side walls connected by a convex outer face, wherein the junction point between the convex outer face and either side wall forms a point.

5. The rotational bit of claim 4 wherein each of said wings has a pair of concave side walls connected by a convex outer face that define a width of said wing, wherein said width of said wing is greatest when measured as a line between said points.

6. The rotational bit of claim 4 wherein when said bit portion is inserted into a recess of a standard Phillips-head fastener and torque applied to said bit, initial contact is created between the recess of said fastener and one of said wing points.

7. The rotational bit of claim 4 wherein said bit is made of a steel having a hardness between 55 and 66 on a Rockwell C hardness scale.

8. The rotational bit of claim 7 wherein said proximate end has a first planar face and said distil end has a second planar face parallel to said first planar face.

9. The rotational bit of claim 8 wherein said convex outer face resides further from said linear axis than a midpoint on said straight line between said points.
